(19) United States
(12) Patent Application Publication
(10) Pub. No.: US 2006/0174296 A1
(43) Pub. Date: Aug. 3, 2006

(54) System and method for evaluating predictive video decoders

(76) Inventor: Sandip Satishkumar Parikh, Middlesex, NJ (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 11/325,840

(22) Filed: Jan. 5, 2006

Related U.S. Application Data
(60) Provisional application No. 60/641,613, filed on Jan. 5, 2005.

(51) Int. Cl. H04N 7/173

(52) U.S. Cl. 725/90

(57) ABSTRACT

Embodiments can include the steps of 1) predicting a test frame or region from a plain frame or region, such as a gray frame or region, using the compressions tools, or features under test, that are to be tested by a test bitstream, and 2) predicting from the test frame or region a plain (such as gray) frame or region. The method can include 3) using the previously produced plain frame to predict a test frame or region using the compressions tools, or features under test, that are to be tested by a test bitstream. This prediction scheme can be identical to the previously used prediction scheme. Thus, the same error will be repeatedly produced in the decoder and, thus, the total error magnitude will be amplified. In some embodiments steps 2 and 3 can be repeated to amplify the errors further.

### CROSS-REFERENCE TO RELATED APPLICATION

This application claims the benefit of U.S. Provisional Patent Application No. 60/641,613, filed Jan. 5, 2005, the entire disclosure of which is hereby incorporated herein by reference.

### FIELD OF THE INVENTION

The present invention relates generally to video decoding, and, more particularly to a system and method for evaluating the decoding of video signals.

### BACKGROUND OF THE INVENTION

The increasing development of digital video/audio technology presents an ever increasing problem of reducing the high cost of compression codecs and resolving the inter-operability of equipment of different manufacturers. To achieve these goals, the Moving Picture Experts Group (MPEG) created the ISO/IEC International Standards 11172-2 (1993) (generally referred to as MPEG-1 video) and 13818-2 (Jan. 20, 1995 draft) (generally referred to as MPEG-2 video). One goal of these standards is to establish a standard coding/decoding strategy with sufficient flexibility to accommodate a plurality of different applications and services such as desktop video publishing, video conferencing, digital storage media and television broadcast.

Although the MPEG standards specify a general coding methodology and syntax for generating a MPEG compliant bitstream, many variations are permitted in the values assigned to many of the parameters, thereby supporting a broad range of applications and interoperability. In effect, MPEG does not define a specific algorithm needed to produce a valid bitstream. Furthermore, MPEG encoder designers are accorded great flexibility in developing and implementing their own MPEG-specific algorithms. This flexibility fosters development and implementation of different MPEG-specific algorithms, thereby resulting in product differentiation in the marketplace. In addition, other video compression algorithms, as known to those of skill in the art, also may be implemented in a flexible manner, thus resulting in variance among the different algorithms.

Digital decoders, such as MPEG video decoders, as well as other types of video decoders, can present a difficult testing problem when compared to analog systems. An analog system typically has minimal or no memory and is generally linear, such that the system's behavior is instantaneous. Thus, the behavior of an analog system can be extrapolated from one signal range to another.

In contrast, digital decoders are highly non-linear and often contain memory. A digital decoder may operate normally over a certain range of a certain parameter, but may fail dramatically for certain other values. In essence, the behavior of a digital decoder cannot be extrapolated from one signal range to another.

Generally, the testing of complex digital systems such as decoders is performed by stimulating the decoder under test with a known sequence of data, and then analyzing the output data sequences or the intermediate data sequences using, e.g., a logic analyzer, to determine if the results conform to expectations. Although this is an effective testing technique, it requires extensive knowledge of the circuit implementation or observation of internal nodes of the particular decoder.

However, in many instances the decoder is a “black-box” that accepts a bitstream (encoded video signal) as input and provides a digital or analog representation of the decoded signal as an output. Due to product differentiation in the marketplace, it may not be possible to acquire such technical information for all decoders. In fact, even if such technical information is available, it may not be cost effective to construct a different test sequence for every decoder.

Therefore, a need exists in the art for a bitstream for testing MPEG-like video decoders, as well as other types of predictive video decoders, without prior knowledge of the particular circuit implementation of any particular decoder. Additionally, a need exists for a method for creating a test sequence or bitstream that will produce visually detectable errors in the image produced by a video decoder if the decoder does not properly decode the bitstream. In addition, a need exists for an error detection method whereby decoder errors are not prone to be cancelled out, and whereby relatively small errors can be visually identified by a user.

Thus, there is a need for an improved system and method for evaluating predictive video decoders.

### SUMMARY OF THE INVENTION

Embodiments of the present invention satisfy these and other needs by providing a system and method for evaluating predictive video decoders. The method and system include a scheme for amplifying visual distortion in test bitstreams for identifying faulty video decoders.

Embodiments of the invention are directed to a scheme for amplifying or increasing small errors in decoders so that final output can be visually checked to ascertain proper operation. Embodiments employ a scheme for amplifying errors in decoders by using repeated prediction in such a way that errors tend not to get cancelled out. This scheme can visually amplify the distortion in presence of very small errors in a decoder, thus facilitating the visual identification, by a user, of relatively small decoder errors.

Embodiments can include 1) predicting a test frame or region from a plain frame or region, such as a gray frame or region, using the compressions tools, or features under test, that are to be tested by a test bitstream, and 2) predicting from the test frame or region a plain (such as gray) frame or region. The method can include 3) using the previously produced plain, or base, frame to predict a test frame or region using the compressions tools, or features under test, that are to be tested by a test bitstream. This prediction scheme can be identical to the previously used prediction scheme. Thus, the same error will be repeatedly produced in the decoder and, thus, the total error magnitude will be amplified. By way of this method, errors in decoder operation will typically not be cancelled out.

In some embodiments, steps 2 and 3 can be repeated to amplify the errors further. As a result, the final gray (or other predetermined image) frame produced after several repetitions can have considerable visual distortion even in presence of very small errors in a decoder, thus facilitating the visual detection of relatively small decoder errors.

### BRIEF DESCRIPTION OF THE DRAWINGS

The present invention will be more readily understood from the detailed description of exemplary embodiments presented below considered in conjunction with the attached drawings, of which:

FIG. 1 is an exemplary system used to test video decoders, in accordance with embodiments of the invention;

FIG. 2 is a flow diagram of an exemplary method for evaluating a video decoder, in accordance with embodiments of the invention;

FIG. 3 is a flow diagram of an exemplary method for evaluating a video decoder, in accordance with embodiments of the invention;

FIG. 4 is an exemplary diagnostic display image for evaluating a video decoder, illustrating a “pass” condition, in accordance with embodiments of the invention;

FIG. 5 is an exemplary diagnostic display image for evaluating a video decoder, illustrating a “fail” condition, in accordance with embodiments of the invention;

FIG. 6 depicts an exemplary title image for a decoder test, in accordance with embodiments of the invention; and

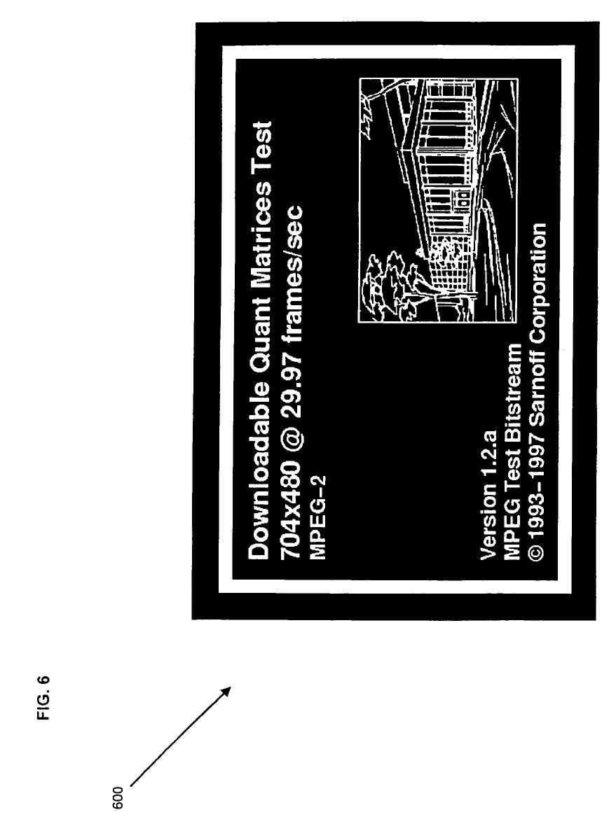

FIG. 7 depicts an exemplary “VERIFY” image for a decoder test, in accordance with embodiments of the invention.

It is to be understood that the attached drawings are for purposes of illustrating the concepts of the invention.

### DETAILED DESCRIPTION OF THE INVENTION

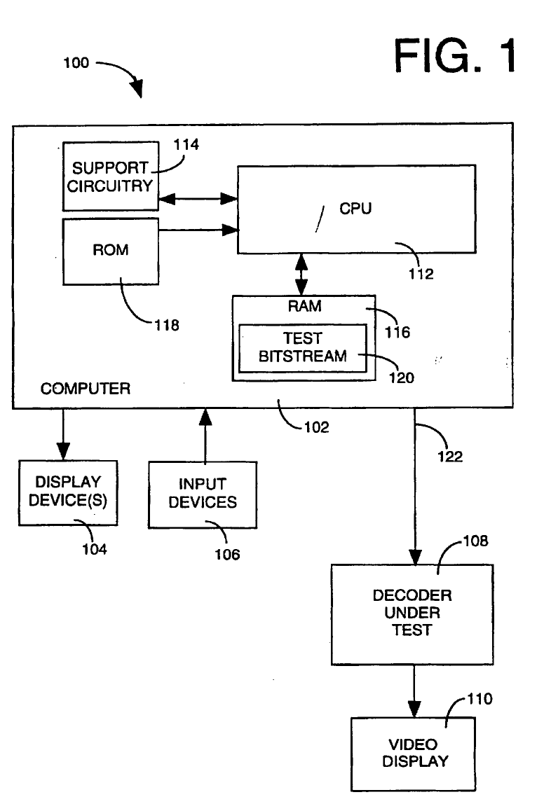

FIG. 1 depicts an exemplary system 100 that produces a particular bitstream, applies the bit stream to the input of a decoder under test (DUT) 108 and permits user observation of the image(s) produced by the decoder on a video display 110. More specifically, the system 100 produces a test bitstream using a general purpose computer system 102. The computer system contains a central processing unit (CPU) 1 12, support circuits 1 14, read only memory (ROM) 118, random access memory 116, display device(s) 104 and input device(s) 106. The CPU 112 is a conventional microprocessor supported by standard hardware such as RAM 116, ROM 118, and general support circuitry 114, e.g., a power supply, a clock, mass memory and other such circuitry all of which is not specifically shown. The CPU 112 recalls a predefined test bitstream 120 from memory and sends, through a serial port 122, the selected bitstream to the decoder under test 108. A user merely observes the video display 110 to view errors that arise during the decoding process. Typically, each bitstream is designed to test one or more specific features of a decoder 108. As such, upon failure of the decoding feature being tested, a distinct pattern of errors will appear in the decoded image(s) appearing on the video display 110.

It should be noted that the DUT may not be a hardware device, but could be a software implementation of a video decoder. As such, the decoder would also reside in RAM and be executed by the CPU. Once executed, the CPU recalls the test bitstream from memory and applies it to the software implementation of the decoder. The decoded output image(s) is displayed upon the display device 104 for the computer system.

When testing a predictive decoder, e.g., MPEG-type decoder, or other types of predictive video decoder, as are known to those of skill in the art, the bitstreams typically are designed to propagate errors from one decoded image to the next such that the errors accumulate and are easily seen in the decoded image. However, in some cases, particularly when errors are small in magnitude, this type of propagation can lead to subsequent decoder errors canceling each other out, and thus escaping detection.

To test the decoding of an image, the test bitstream must contain specific information related to a series of images.

Embodiments of the invention can uses a bitstream containing a predefined object. This frame sequence, when properly decoded, produces a sequence of images having a predefined pattern or object in the images. When the decoder improperly decodes the bitstream, the predefined object appears distorted. The nature of the distortion is indicative of the decoding error.

Specifically, the bitstream can describe a predefined image that, when correctly decoded, produces a uniform gray region within the decoded image. However, an error in the decoding process for either direction of motion vector will be visible in the image as a distortion in the uniform gray region. In addition, because the same features under test are applied to the previously created test image, any decoder errors will typically not be canceled out during subsequent iterations.

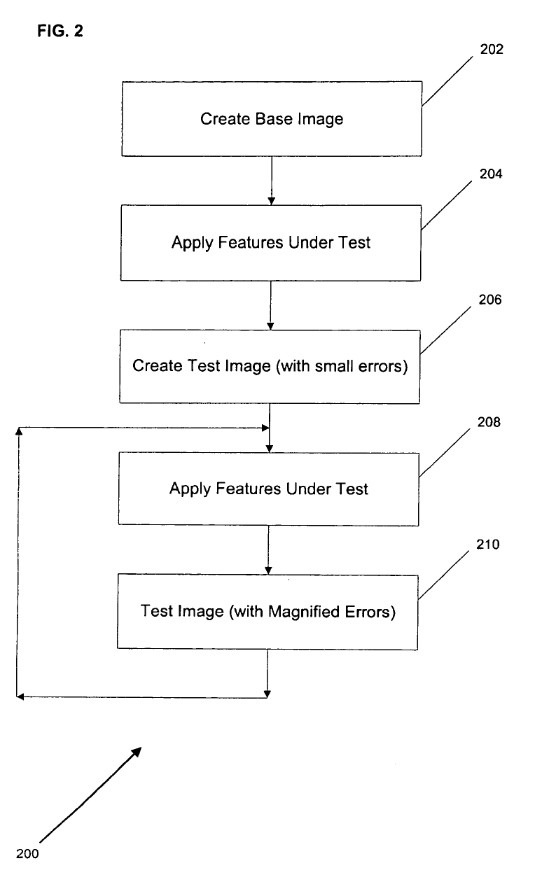

FIG. 2 depicts a flow diagram of an illustrative method 200 for evaluating a video decoder. The method 200 is typically executed on a general purpose computer system such as that depicted in FIG. 1. The method 200 begins at step 202 wherein a base image is created. At step 204, the specific features under test are applied to the base image. Next, at step 206, a test image is created. If an error arises in the decoding process as the features under test are applied to the base image, a visual distortion in the test image will appear. In circumstances where the decoding error is relatively small, the visual distortion will also be correspondingly relatively small, possibly making the error difficult for a user to visually detect.

Next, in step 208, the features under test are applied to the previously created test image. The result, in step 210, is a test image with a magnified error. Step 208 can be repeated such that the features under test can be applied to the test image with the magnified error, thus resulting in a further magnified error with each iteration of the application of the features under test in step 208.

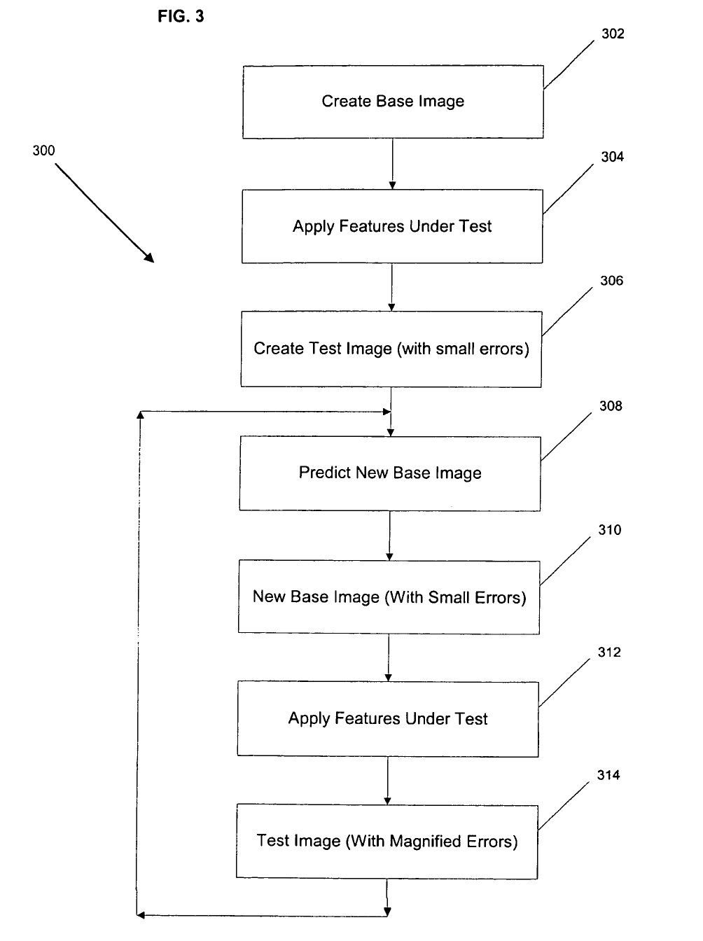

FIG. 3 depicts a flow diagram of an illustrative method 300 for evaluating a video decoder. The method 300 begins at step 302 wherein a base image is created. At step 304, the specific features under test are applied to the base image. Next, at step 306, a test image is created. If an error arises in the decoding process as the features under test are applied to the base image, a visual distortion in the test image will appear. In circumstances where the decoding error is relatively small, the visual distortion will also be correspondingly relatively small, possibly making the error difficult for a user to visually detect.

Next, in step 308, a new base image is predicted. In step 310, a new base image is created. If an error arises in the decoding process as the features under test are applied to the predicted base image, a visual distortion in the test image will appear. In circumstances where the decoding error is relatively small, the visual distortion will also be correspondingly relatively small, possibly making the error difficult for a user to visually detect.

Next, in step 312, the features under test are applied to the previously created new base image. The result, in step 314, is a test image with a magnified error. Steps 308 through 314 can be repeated such that the features under test can be repeatedly applied to the base image with the magnified error, thus resulting in a further magnified error with each iteration of the application of the features under test. In addition, as described above, with respect to method 200, because the same features under test are applied to the previously created base image, any decoder errors will typically not be canceled out during subsequent iterations.

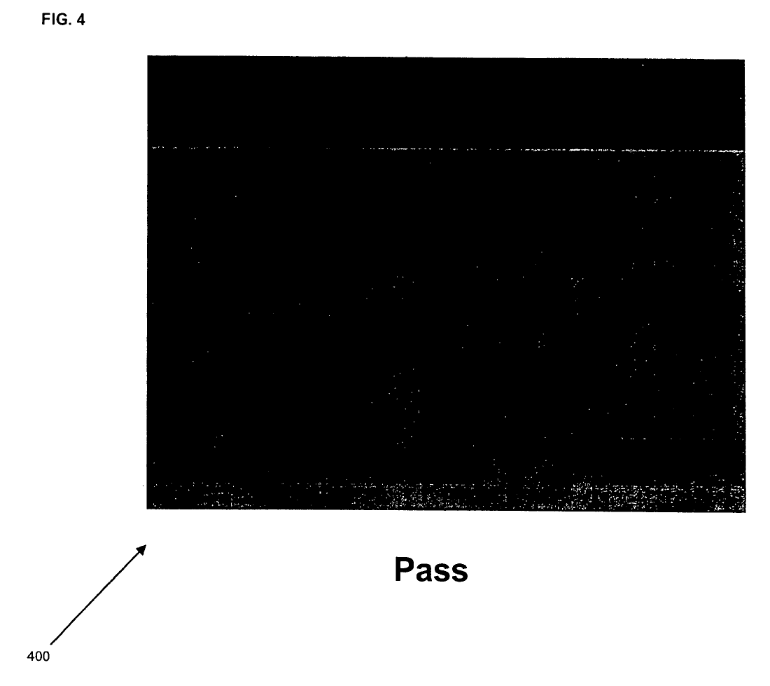

The result of the encoding process is a method that tests the effectiveness of a decoder's capability in decoding images. With reference to FIG. 4, if no errors are detected, image 400 will not display any significant distortions.

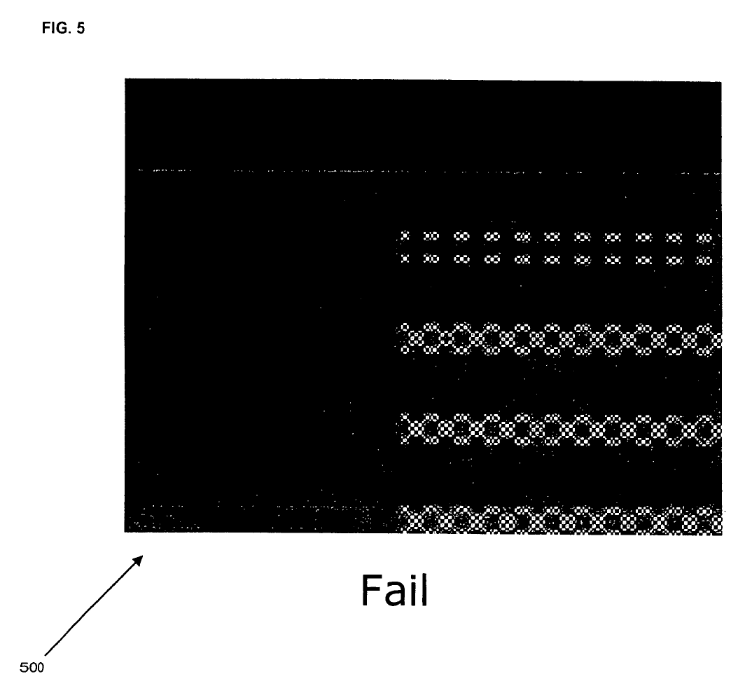

By repeating the features under test, via a bitstream, as a decoder input, any errors in the decoding process will appear in the decoded image as imperfections in the base image, which, in certain embodiments, is a uniformly gray region, so that visual distortions maybe readily identified by a user. The shape or look of the distortion is indicative of the type of error that has occurred. Typical errors, as depicted by image 500 in FIG. 5, can include bright dots and/or lines within the decoded image. Thus, a user, by merely observing the video display as the bitstream is decoded, can easily see that an error has occurred and what type of error has occurred. As stated above, by way of this matter, relatively small errors can be magnified such that they will be easily visually identified.

In certain embodiments, a title image 600 is optionally appended to the beginning of the frame sequence used to generate the test bitstream. The title image is coded along with the test images and appears as a decoded image to identify the type of test being conducted.

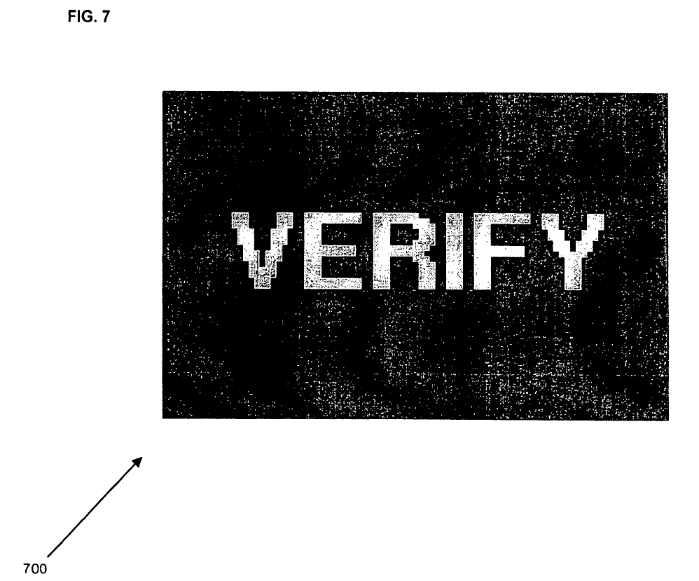

Each test bitstream typically terminates with an encoded image (generally referred to as a termination image) having a particular pixel pattern that indicates the test is complete. As an illustration, the last image contains the word “VERIFY” and is known as the VERIFY screen or image. This image 700 is depicted in FIG. 7. The VERIFY screen contains the word VERIFY which has a blocky appearance, e.g., uses a blocky font to ease coding of the image. Preferably, the blocks that comprise the text are aligned to the block sized used in the coding process, e.g., 8.times.8 pixel blocks used in the MPEG coding process. To further improve coding efficiency, the background of the VERIFY screen is typically a uniform gray color. As such, the fewer bits used to code the VERIFY image, the more bits available for coding the test images themselves.

It is to be understood that the exemplary embodiments are merely illustrative of the invention and that many variations of the above-described embodiments can be devised by one skilled in the art without departing from the scope of the invention. It is therefore intended that all such variations be included within the scope of the following claims and their equivalents.

What is claimed is:

1. A method of evaluating a video decoder, the method comprising:
forming a region of a video frame having a base image;
generating a test image from the base image by the use of features under test; and
applying, a plurality of times, the features under test to the test image, to magnify any resultant errors

2. The method of claim 1, wherein the base image comprises a single color.

3. The method of claim 1, wherein the base image is a solid gray color.

4. The method of claim 1, further comprising:
forming a new base image from each test image; and
applying the features under test to each new base image.

5. The method of claim 4, wherein all of the generated new base images are identical and the features under test are identically applied for each of the repetitions.

6. The method of claim 4, wherein a portion of the generated new base images are identical and the features under test are identically applied for each of the repetitions.

7. The method of claim 4, wherein a portion of the generated new base images are identical and the features under test are identically applied for a portion of the repetitions.

8. The method of claim 1, wherein a final verification frame is created from the resultant test image, wherein errors can be visually detected by a user.

9. The method of claim 4, wherein a final verification frame is created from the new base image, wherein errors are easily detected visually by a user.

10. A system for evaluating a video decoder, the system being configured to perform the steps of:
forming a region of a video frame having a base image;
generating a test image from the base image by the use of features under test; and
applying, a plurality of times, the features under test to the test image, to magnify any resultant errors

11. The system of claim 10, wherein the base image comprises a single color.

12. The system of claim 10, wherein the base image is a solid gray color.

13. The system of claim 10, the system being configured to perform the steps of:
forming a new base image from each test image; and
applying the features under test to each new base image.

14. The system of claim 13, wherein all of the generated new base images are identical and the features under test are identically applied for each of the repetitions.

15. The system of claim 13, wherein a portion of the generated new base images are identical and the features under test are identically applied for each of the repetitions.

16. The system of claim 13, wherein a portion of the generated new base images are identical and the features under test are identically applied for a portion of the repetitions.

17. The system of claim 10, wherein a final verification frame is created from the resultant test image, wherein errors can be visually detected by a user.

18. The system of claim 13, wherein a final verification frame is created from the new base image, wherein errors are easily detected visually by a user.

19. A computer readable medium, the medium containing instructions to perform the steps of:
forming a region of a video frame having a base image;
generating a test image from the base image by the use of features under test; and
applying, a plurality of times, the features under test to the test image, to magnify any resultant errors

20. The computer readable medium of 19, wherein the base image comprises a single color.

21. The computer readable medium of claim 19, wherein the base image is a solid gray color.

22. The computer readable medium of claim 19, the medium containing instructions to perform the steps of:
forming a new base image from each test image; and
applying the features under test to each new base image.

23. The computer readable medium of claim 22, wherein all of the generated new base images are identical and the features under test are identically applied for each of the repetitions.

24. The computer readable medium of claim 22, wherein a portion of the generated new base images are identical and the features under test are identically applied for each of the repetitions.

25. The computer readable medium of claim 22, wherein a portion of the generated new base images are identical and the features under test are identically applied for a portion of the repetitions.

26. The computer readable medium of claim 19, wherein a final verification frame is created from the resultant test image, wherein errors can be visually detected by a user.

27. The computer readable medium of claim 22, wherein a final verification frame is created from the new base image, wherein errors are easily detected visually by a user.
